(19) United States
(12) Patent Application Publication
(10) Pub. No.: US 2012/0075204 A1
(43) Pub. Date: Mar. 29, 2012

(54) Using a Touch-Sensitive Display of a Mobile Device with a Host Computer

(75) Inventors: Abraham Murray, Scituate, MA (US); Jeremy Faller, Braintree, MA (US)

(73) Assignee: GOOGLE INC., Mountain View, CA (US)

(21) Appl. No.: 12/891,771

(22) Filed: Sep. 27, 2010

(51) Int. Cl. G06F 3/041; H04H 20/71

(52) U.S. Cl. 345/173; 370/312

(57) ABSTRACT

A touch-sensitive display of a mobile device is used to control applications executing on a host computer. A communications link is established between the host computer and the mobile device. A graphical user interface (GUI) from the host computer is delegated to the touch-sensitive display of the mobile device via the communications link. The mobile device is adapted to show the delegated GUI on the touch-sensitive display of the mobile device, wherein a user can interact with the displayed GUI. The host computer receives data describing the user interactions with the delegated GUI shown on the touch-sensitive display of the mobile device via the communications link. The host computer executes an instruction on the host computer based in part on the received data describing the user interaction.

### FIELD OF THE INVENTION

The present invention relates to the field of computing and more specifically to using a touch-sensitive display of a mobile device to remotely control a computer.

### BACKGROUND OF THE INVENTION

Mobile devices such as smart phones, portable digital assistants (PDAs) and tablet computers have become ubiquitous. Smart mobile devices allow users to send and receive emails, access the World Wide Web using a browser and perform many tasks that formerly required a desktop or laptop computer. Mobile devices such as APPLE's IPAD tablet and MOTOROLA's DROID phone additionally provide touch-sensitive displays. Such devices, for example, display the user interface (UI) components on a touch-sensitive display and accept user input using the same display. Such touch-sensitive displays are useful for a wide variety of tasks because the displays allow the user to simultaneously view and interact directly with the UI using manual gestures.

However, mobile devices having such touch-sensitive displays often lack the processing capabilities required to execute resource-intensive applications. For example, touch-sensitive displays can be useful for image processing tasks, but mobile devices having such displays generally lack the processing capabilities required to run sophisticated image processing applications. While more powerful computers have the resources to run such applications, these types of computers typically lack touch-sensitive displays.

### SUMMARY OF THE INVENTION

The above and other needs are addressed by a method, computer and computer-readable storage media storing instructions for using a touch-sensitive display of a mobile device with a host computer. Embodiments of the method comprise establishing a communications link between the host computer and the mobile device. The method further comprises delegating a mirrored graphical user interface (GUI) at a first resolution, from the host computer to the touch-sensitive display of the mobile device via the communications link; wherein the mobile device is adapted to show the delegated GUI on the touch-sensitive display of the mobile device at a second resolution different than the first resolution. Additionally, the host computer receives data describing a user interaction with the delegated GUI displayed on the touch-sensitive display of the mobile device via the communications link. The method executes an instruction on the host computer based at least in part on the received data describing the user interaction.

Embodiments of the computer comprise a non-transitory computer-readable storage medium storing executable computer program instructions. The instructions, in turn comprise establishing a communications link between the host computer and the mobile device. The instructions further delegate a mirrored graphical user interface (GUI) at a first resolution, from the host computer to the touch-sensitive display of the mobile device via the communications link; wherein the mobile device is adapted to show the delegated GUI on the touch-sensitive display of the mobile device at a second resolution different than the first resolution. The instructions additionally permit the host computer to receive data describing a user interaction with the delegated GUI displayed on the touch-sensitive display of the mobile device via the communications link. The instructions execute another instruction on the host computer based at least in part on the received data describing the user interaction. The computer additionally comprises a processor for executing the computer program instructions.

Embodiments of the computer-readable storage medium store executable computer program instructions. The instructions, in turn comprise establishing a communications link between the host computer and the mobile device. The instructions further delegate a mirrored graphical user interface (GUI) at a first resolution, from the host computer to the touch-sensitive display of the mobile device via the communications link; wherein the mobile device is adapted to show the delegated GUI on the touch-sensitive display of the mobile device at a second resolution different than the first resolution. The instructions additionally permit the host computer to receive data describing a user interaction with the delegated GUI displayed on the touch-sensitive display of the mobile device via the communications link. The instructions execute another instruction on the host computer based at least in part on the received data describing the user interaction.

### BRIEF DESCRIPTION OF THE DRAWINGS

FIG. 1 is a high-level block diagram illustrating a computing environment for using a mobile device to control applications executing on a host computer, according to one embodiment.

FIG. 2 is a high-level block diagram illustrating an example computer for use as the host computer and/or mobile device.

FIG. 3 is a high-level block diagram illustrating modules within a host computer according to one embodiment.

FIG. 4 is a high-level block diagram illustrating modules within a mobile device according to one embodiment.

FIG. 5 is a transaction diagram illustrating a method of using a touch-sensitive display of a mobile device to interact with a host computer according to one embodiment.

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### DETAILED DESCRIPTION OF THE INVENTION

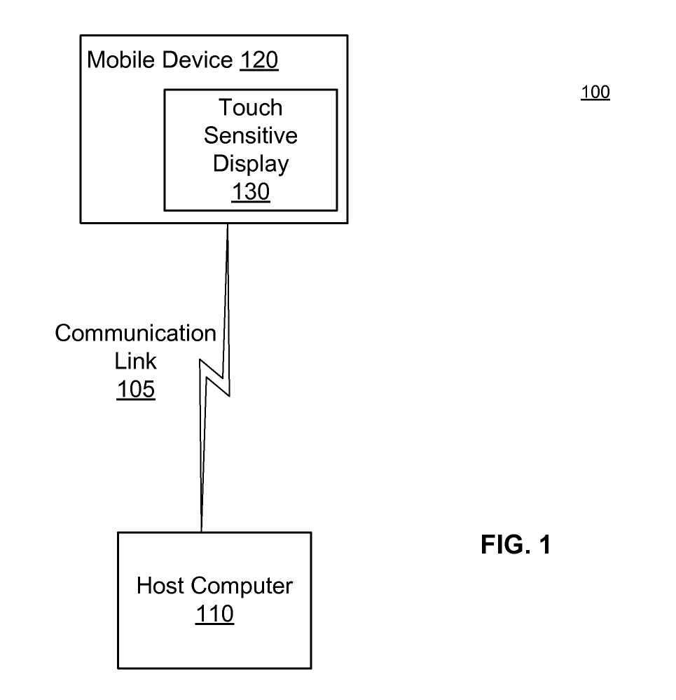

FIG. 1 is a high-level block diagram illustrating a computing environment 100 for using a mobile device to control applications executing on a host computer, according to one embodiment of the present disclosure. As shown, the computing environment 100 includes a host computer 110 and a mobile device 120 having a touch-sensitive display 130. The host computer 110 and mobile device 120 are connected through a communications link 105. At a high level, a user uses the touch-sensitive display 130 of the mobile device 120 to control and/or interact with applications executing on the host computer 110, thereby allowing the user to obtain the benefits of using a touch-sensitive display in combination with the processing power and other computational resources available on the host computer 110.

The host computer 110 is a computing device such as a desktop or laptop computer and executes an operating system capable of executing one or more applications. In one embodiment, the operating system is a graphical operating system such as a variant of MICROSOFT WINDOWS, APPLE OS X, or the GOOGLE CHROME OS. The operating system provides a graphical user interface (GUI) that allows the user to interact with the host computer 110 via images displayed on a display. Via the GUI, the user can execute applications on the host computer for performing tasks such as web browsing, word processing, and image editing. In one embodiment, the operating system supports multiple displays and display types. For example, the operating system can include functionality to provide the GUI on multiple displays of differing resolutions. In addition, the operating system supports various types of input/output (I/O) devices. The operating system also supports communications via a network interface.

The mobile device 120 is a portable computing device with a touch-sensitive display 130. For example, the mobile device 120 can be a mobile phone, a PDA, a tablet computer etc. The touch-sensitive display 130 is an electronic visual display that both displays graphical information and accepts input via touches of the device with a finger, hand, or other passive object. The touch-sensitive display 130 can use different technologies to detect touch in different embodiments, such as resistance- and capacitance-based technologies. In addition, the touch-sensitive display 130 can support multi-touch functionality that allows the display to detect gestures. In addition, external peripherals such as keyboards and mice can be connected to the mobile device 120 via a wired or wireless communications link. Furthermore, the mobile device 120 can include location-determination and motion/orientation detection capabilities.

As with the host computer 110, the mobile device 120 executes an operating system that, in turn, is capable of executing one or more applications. For example, the mobile device can be an IPAD executing a variant the APPLE iOS operating system. Likewise, the mobile device operating system supports communications via a network interface. The computational resources of the mobile device 120 may differ from those of the host computer 110. Generally, the mobile device 120 has fewer processing resources than the host computer 110. However, there may be aspects, such as graphics processing, where the mobile device 120 has greater processing resources than the host computer 110.

The host computer 110 and mobile device 120 communicate via a communications link 105. In one embodiment, the communications link 105 uses a wireless networking technology such as BLUETOOTH, WI-FI (IEEE 802.11), or an Infrared Data Association (irDA)-based technology. The communications link 105 can be a point-to-point link that directly couples the host computer 110 and mobile device 120 without passing through any intermediate device, or use a different network topology. The host computer 110 and mobile device 120 can exchange information over the communications link 105 using networking protocols such as the transmission control protocol/Internet protocol (TCP/IP) and the hypertext transport protocol (HTTP). The data exchanged over the communications link 105 can be represented using technologies and/or formats including the hypertext markup language (HTML) and the extensible markup language (XML). In addition, the communications link 105 can be encrypted using conventional encryption technologies such as the secure sockets layer (SSL) and Secure HTTP. The communications link 105 is wired in some embodiments.

In one embodiment, the mobile device 120 interacts with the host computer 110 via the communications link 105 to register the touch-sensitive display 130 as an I/O device for the host computer. Thus, a user can use the touch-sensitive display 130 to interact with the operating system and applications executing on the host computer 110. For example, an application on the host computer 110 can output a GUI to the touch-sensitive display 130 that allows the user to control the application. Thus, the user gains the benefits that control by a touch-sensitive display provides, while also using the processing resources available on the host computer 110. Moreover, processing tasks can also be delegated from the host computer 110 to the mobile device 120 and vice-versa when appropriate. For example, graphics processing tasks can be delegated from the host computer 110 to the mobile device if the latter entity has the greater graphics processing resources.

In some embodiments, multiple mobile devices 120 are linked to the host computer 110 through the communications link 105. The multiple mobile devices 120 can be used by a single user or by multiple users to interact with one or more portions of an operating system and applications executing on the host computer using each device's touch-sensitive display 130. The multiple users can interact with the host computer 110 from various geographic locations, passing controls back and forth via applications executing on each mobile device 120.

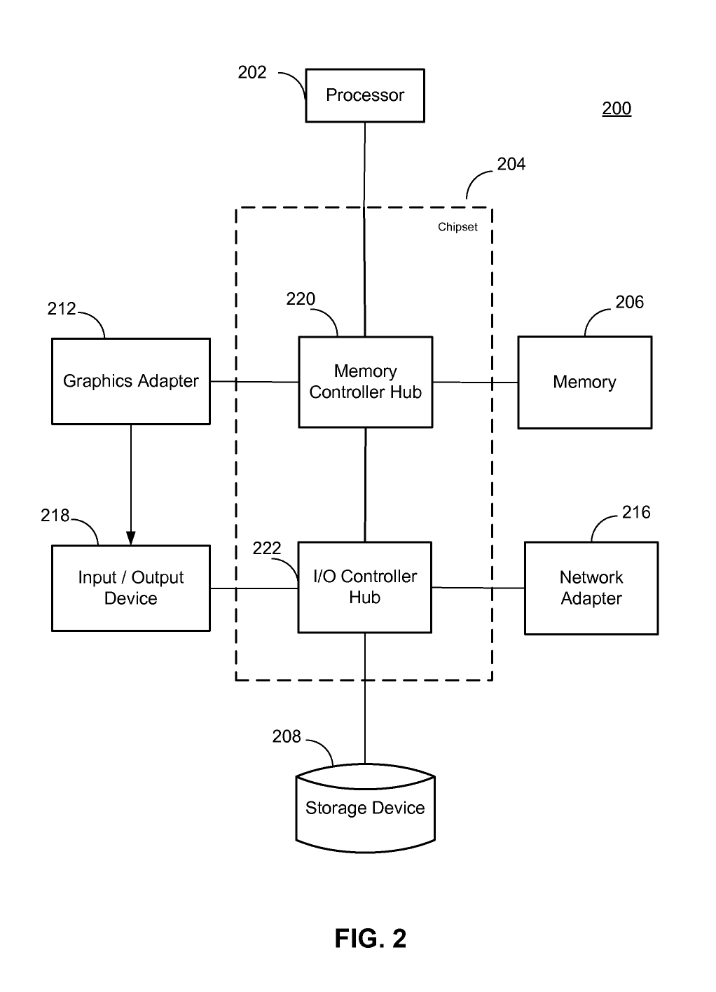

FIG. 2 is a high-level block diagram illustrating an example computer 200 for use as the host computer 110 and/or mobile device 120. Illustrated are at least one processor 202 coupled to a bus 204. Also coupled to the bus 204 are a memory 206, a non-transitory storage device 208, a graphics adapter 212, input device 218 and a network adapter 216. The processor 202 may be any general-purpose processor such as an INTEL x86 or APPLE A4 compatible-CPU. The storage device 208 is, in one embodiment, a hard disk drive but can also be another device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The type of input device 218 varies depending upon the embodiment. For a host computer 110 the input device can include a keyboard and/or mouse. For a mobile device 120 the input device can include a touch-sensitive display in addition to a keyboard, mouse or other peripheral devices. The graphics adapter 212 displays images and other information on a display, such as a traditional monitor or a touch-sensitive display. The network adapter 216 couples the computer system 200 to the communications link 105.

As is known in the art, the computer system 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202.

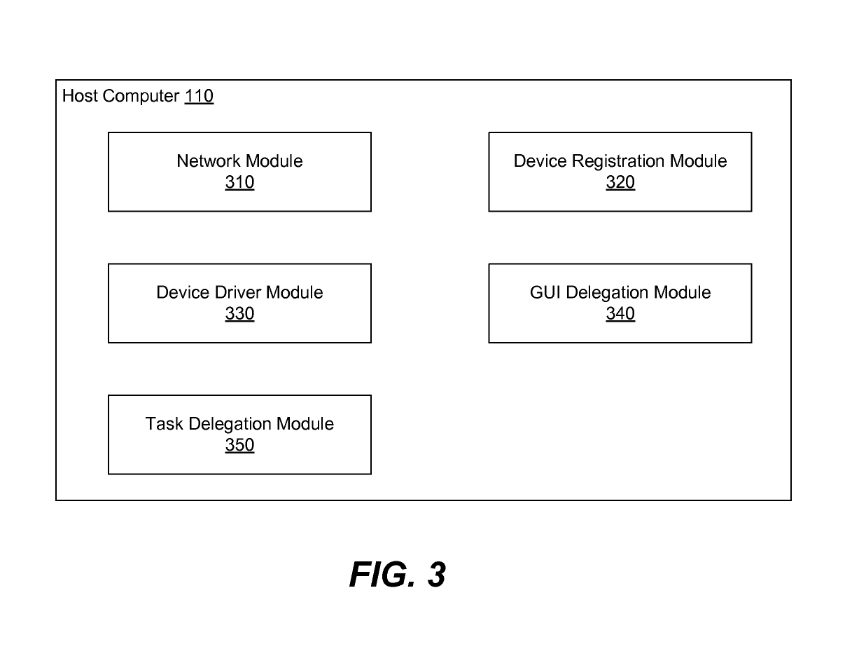

FIG. 3 is a high-level block diagram illustrating modules within a host computer 110 according to one embodiment. Those of skill in the art will recognize that other embodiments can have different and/or other modules than the ones described here, and that the functionalities can be distributed among the modules in a different manner. As shown in FIG. 3, the host computer 110 includes a network module 310, a device registration module 320, a device driver module 330, a GUI delegation module 340, and a task delegation module 350.

The network module 310 establishes a connection with the mobile device 120 via the communications link 105. As described above, the communications link 105 can use a variety of technologies in different embodiments, and the network module 310 supports communications via the particular communications technology being used in the given embodiment. For example, the network module 310 can establish the connection with the mobile device 120 via BLUETOOTH.

In one embodiment, the network module 310 supports multicast network communications protocols via the communications link 105 between the one or more mobile devices 120 and the host computer 110. The multicast network protocol allows for efficient communication between the mobile devices 120 and the host computer 110 by allowing the host computer to continually push information to the mobile devices. Multicast network protocols also allow the host computer 110 to push desktop display information to all participating mobile devices 120 simultaneously, with the mobile devices individually identifying and using the information directed to the specific mobile devices. Multicasting thus allows the network module 310 to support bandwidth-intensive graphics processing tasks by supporting greater transmission rates than allowed by handshaking protocols such as TCP/IP.

The device registration module 320 registers the touch-sensitive display 130 of the mobile device 120 as an I/O device for the host computer 110. In one embodiment, the device registration module 320 receives information from the mobile device 120 describing the touch-sensitive display 130 and other device capabilities. For example, the information can describe the resolution and color depth of the touch-sensitive display 130, and describe the input capabilities of the display. The device registration module 320 uses this information to configure the host computer 110 to establish the display aspect of the touch-sensitive display 130 as an output device for the host computer, and to establish the touch-sensitive aspect of the touch-sensitive display 130 as an input device for the host computer. For example, some operating systems of host computers 110 include functionality supporting locally-connected touch-sensitive displays. The device registration module 320 uses this functionality to establish the mobile device's touch-sensitive display as an I/O device for the host computer, even though the mobile device 120 is not locally connected. In addition, the device registration module 320 can register any peripherals connected to the mobile device 120 as an I/O device for the host computer. For example, the device registration module 320 can register an external keyboard linked to the mobile device 120 as a peripheral of the host computer 110.

In one embodiment, the device registration module 320 registers the resolution of the mobile device's touch-sensitive display 130 based on the orientation reported by the mobile device 120. For example, the device registration module 320 can receive information from the mobile device 120 indicating the orientation of the device, and then set the horizontal and vertical resolutions of the display registered with the host computer 110 to reflect the current resolution. Additionally, the device registration module 320 can change the registered resolution of the display if the mobile device 120 reports that its orientation has changed.

The device registration module 320 can also store registration information associated with mobile devices 120 that have previously connected to the host computer 110. For example, the device registration module 320 can store the previous orientation of a mobile device 120 and the desktop application windows which were extended to the mobile device 120 in that orientation. As discussed in greater detail below, the host computer 110 can use the stored device registration information to automatically send display information associated with particular application windows or a mirrored GUI to a connected mobile device 120.

The device driver module 330 interfaces between the host computer 110, the I/O devices registered by the device registration module 320 and the touch-sensitive displays 130 of the mobile devices 120. In one embodiment, the device driver module 330 serves as an abstraction layer that makes the touch-sensitive display 130 appear to the host computer 110 as if it were locally connected, even though the touch-sensitive display is in fact remote and connected via the communications link 105. To this end, the driver module 330 receives data output by the host computer 110 (i.e., from an operating system and/or application executing on the host computer) intended for the registered touch-sensitive display and converts the data into a format suitable for communication to the mobile device 120 via the communications link 105. Similarly, the driver module 330 receives via the communications link 105 data output by the mobile device 120 (e.g., data describing user interactions with a GUI on the touch-sensitive display 130 of the mobile device 120 and/or with other peripherals associated with the mobile device) and submits the data to the host computer 110 (i.e., to the operating system or application) in a format the host computer expects to receive. The host computer 110 can then execute instructions based on the user's interactions, such as activating a particular capability of an application. In one embodiment, the driver module 330 receives multi-touch and gesture controls from the mobile device 120 and converts the controls to a format suitable for the operating system of the host computer 110.

In another embodiment the device registration module 320 and/or device driver module 330 interact to register the touch-sensitive display 130 of the mobile device 120 at a display primitives level of the operating system. In such an embodiment, the host computer's operating system can communicate directly with the mobile device in the language of the host computer's operating system. This technique allows the mobile device 120 to perform its own drawing acceleration and other functions using its own capabilities. Moreover, this technique can be used for user input as well. Using the display primitives level of the operating system enables decreased latency for communications between the mobile device 120 and host computer 110.

The GUI delegation module 340 controls how the GUI for the host computer is delegated to the touch-sensitive display 130 of the mobile device 120. That is, the GUI delegation module 340 controls how the mobile device 120 is used to interact with the host computer 110. The GUI delegation module 340 also sends information to the mobile device 120 describing the GUI to present on the touch-sensitive display 130.

In one embodiment, the GUI delegation module 340 sends a list of active applications and application windows to the mobile device 120. The user of the mobile device 120 can use the touch-sensitive display 130 to select the applications or windows to control on the mobile device 120. In addition, the GUI delegation module 340 can receive user selections and move or resize a GUI of the selected application for the touch-sensitive display 130. In another embodiment, the GUI delegation module 340 automatically generates a GUI for the one or more connected mobile devices 120 based on the preset user preferences or based on prior communications history between the host computer 110 and the mobile device 120 stored by the device registration module 320.

An embodiment of the GUI delegation module 340 supports a variety of delegation modes. In one such mode, the GUI delegation module 340 extends the GUI from a display of the host computer 110 onto the mobile device's touch-sensitive display 130. Thus, the touch-sensitive display 130 acts as an additional display area for the host computer 110. In such an embodiment, the GUI delegation module 340 can direct certain aspects of the host computer's GUI to the display area of the touch-sensitive display 130. For example, the GUI delegation module 340 can fit a window for a certain application executing on the host computer 110 within the display area corresponding to the touch-sensitive display 130 so that the user can use the touch-sensitive display to interact with the application.

In another delegation mode, the GUI delegation module 340 mirrors the GUI of the host computer 110 to the mobile device's touch-sensitive display 130. Thus, the GUI delegation module 340 causes the touch-sensitive display 130 to replicate the GUI that the host computer 110 displays on its local display. The user can therefore use the touch-sensitive display to interact with the entire GUI of the host computer. In one embodiment of mirror mode where the native resolutions of the host computer's display and the mobile device's touch-sensitive display 130 are different, the GUI delegation module 340 generates a mirrored version the GUI scaled to fit on the touch-sensitive display 130 of the mobile device 120. The user can interact with the touch-sensitive display 130 to zoom into a portion of the GUI, so that the user views the GUI on the mobile device at the same or greater resolution as on the host computer 110.

In an additional delegation mode, the GUI delegation module 340 generates a customized GUI adapted to the touch-sensitive display and delegates it to the touch-sensitive display 130. The customized GUI can replace the native GUI of the host computer 110 and serve as a remote desktop. With a customized GUI, the user of the mobile device 120 can control the host computer 110 using a GUI specific to the touch-sensitive display 130.

In another delegation mode, the GUI delegation module 340 generates a customized GUI responsive to the orientation of the touch-sensitive display 130. For example, the GUI delegation module 340 can receive information from the device registration module 320 indicating a change in orientation of the mobile device 120. The GUI delegation module 340 automatically adjusts the mirrored or extended GUI responsive to the updated device resolution information. Similarly, in one delegation mode, the GUI delegation module 340 generates a customized GUI responsive to the zoom level of GUI displayed on the touch-sensitive display 130. In another delegation mode where there are multiple mobile devices 120, the GUI delegation module 340 determines the zoom levels of each of the touch-sensitive displays 130 of the connected mobile devices 120 and generates a GUI for each of the mobile devices at the varying zoom levels. For example, the GUI delegation module 340 can generate a GUI for close-in interaction such as detailed graphics work for one mobile device 120 and another GUI for a zoomed out view of the same screen area for another mobile device 120.

In still another delegation mode, the GUI delegation module 340 generates a GUI based on positional information supplied by the mobile device 120. Motion sensors on board the mobile device 120 generate information describing the position/orientation of the mobile device 120 and the GUI delegation module 340 uses this information to update the GUI. For example, the GUI delegation module 340 allows a user to move the mobile device 120 and thereby “move” the portion of the GUI displayed on the touch-sensitive screen 130, such that the user can pan through the GUI by moving the device. Similarly, if there are multiple mobile devices 120, the GUI delegation module 340 can configure the portions of the GUI shown on the touch-sensitive displays 130 of the devices based on the devices' respective positions and orientations, and reconfigure the GUI should one device change position relative to another.

The task delegation module 350 delegates processing tasks between the host computer 110 and mobile device 120. In one embodiment, the task delegation module 350 maintains information describing the processing capabilities of the host computer 110 and mobile device 120. The task delegation module 350 monitors tasks requested to be performed on the host computer 110 and/or mobile device 120 by, e.g., monitoring communicates passing through the device driver module 330, and causes the task to execute on the machine having the processing capabilities to which it is best suited. For example, if the mobile device 120 is optimized to perform certain image processing tasks, and the user uses the touch-sensitive display 130 to request such a task, the task delegation module 350 can delegate the task to the mobile device 120 by sending information to the mobile device describing the task. The task delegation module 350 can also receive information from the mobile device 120 describing a task delegated to the host computer 110 by the mobile device 120. In such a case, the task delegation module 350 interacts with components of the host computer, such as the operating system and applications, to perform the requested task and output the results of the task to the mobile device 120.

Further, in an embodiment where the GUI delegation module 340 has delegated a customized GUI to the touch-sensitive display 130, the task delegation module 350 receives user interaction with the GUI and delegates a task to the host computer 110 based on the interaction. For example, if the user is using the customized GUI to control an image processing application executing on the host computer 110 and uses the GUI to request a specific type of image processing, the task delegation module 350 interacts with the application on the host computer to perform the requested processing.

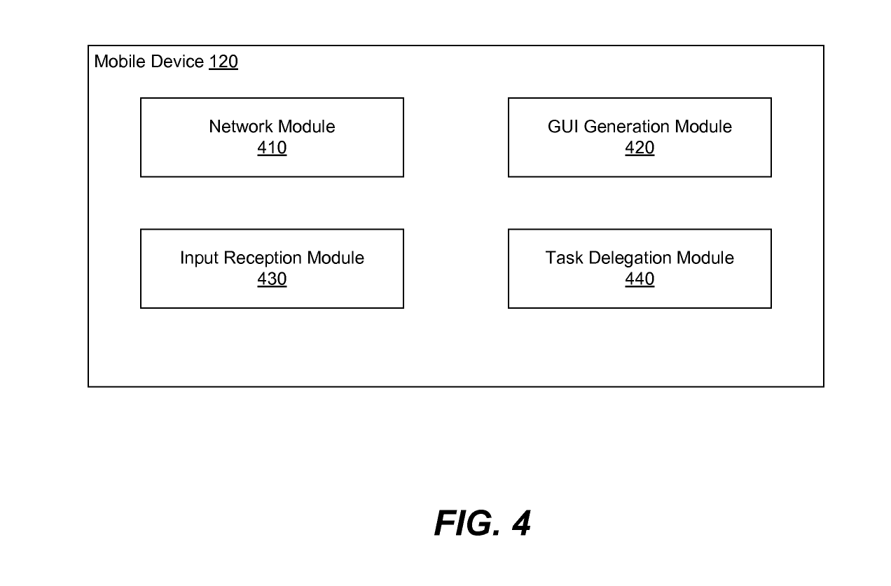

FIG. 4 is a high-level block diagram illustrating modules within a mobile device 120 according to one embodiment. Those of skill in the art will recognize that other embodiments can have different and/or other modules than the ones described here, and that the functionalities can be distributed among the modules in a different manner. As shown in FIG. 4, the mobile device 120 includes a network module 410, a GUI generation module 420, an input reception module 430 and a task delegation module 440.

The network module 410 establishes a connection with the host computer 110 via the communications link 105. Thus, the network module 410 in the mobile device 120 is a counterpart of the network module 310 of the host computer 110 and performs complementary functions. The network module 410 performs tasks such as providing information about characteristics of the mobile device 120 to the host computer 110, receiving information describing a GUI to present on the touch-sensitive display 130, and providing information describing user input made via the touch-sensitive display to the host computer 110.

The GUI generation module 420 generates a GUI for the touch-sensitive display 130. In one embodiment, the GUI generation module 420 receives information from the GUI delegation module 340 of the host computer 110 describing the GUI to present, and generates a corresponding GUI on the touch-sensitive display 130. As discussed above, depending upon the mode the touch-sensitive display 130 can extend or mirror the host computer's GUI, and can also show a customized GUI.

The input reception module 430 receives user input from the touch-sensitive display 130 and provides the input to the host computer 110. The user interacts with the GUI displayed on the touch-sensitive display 130 through touches and gestures. For example, the user can interact with the touch-sensitive display using multi-touch or gesture controls. The input reception module 430 generates information describing the user interactions and sends the information to the host computer 110 via the network module 410. For example, if the user touches a particular menu option presented by the GUI, the input reception module 430 communicates the user's selection of that option to the host computer 110 via the network module 410. In another embodiment, the input reception module 430 receives user input from peripheral devices of the mobile device 120. For example, a keyboard or a mouse can be attached to the mobile device to allow a user to input information. In such an embodiment, the input reception module 430 receives user input from the mobile device's operating system and provides the input to the host computer 110.

In the embodiment where the touch-sensitive display 130 of the mobile device 120 communicates with the host computer 110 at a display primitives level of the host computer's operating system, the GUI generation module 420 and/or input reception module 430 communicate directly with the operating system. Thus, the GUI generation module 420 performs its own drawing acceleration, user input, and other functions using the mobile device's native capabilities. In this embodiment, a portion of the host computer's OS is, in essence, running on the mobile device 120 and communicating back to the host computer 110. The communications can be performed using remote procedure calls (RPCs) and/or other techniques.

The task delegation module 440 delegates processing tasks between the host computer 110 and mobile device 120 in cooperation with the task delegation module 350 of the host computer 110. In one embodiment, the task delegation module 440 receives information from the host computer 110 describing a task delegated to the mobile device 120. The task delegation module 440 interacts with other components of the mobile device 120, such as its operating system and/or applications executing on the mobile device to perform the requested task and provide output resulting from the task to the host computer 110.

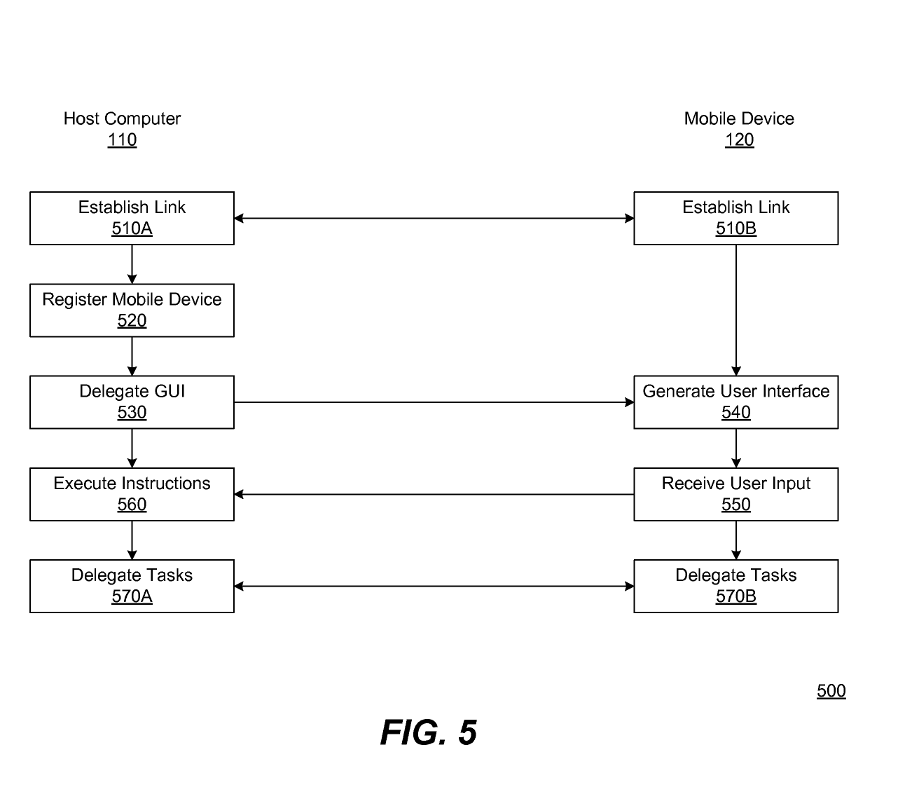

FIG. 5 is a transaction diagram illustrating a method 500 of using the touch-sensitive display 130 of the mobile device 120 to interact with the host computer 110 according to one embodiment. The host computer 110 and mobile device 120 establish 510 the communications link 105. The touch-sensitive display 130 of the mobile device 120 is registered 520 as an I/O device for the host computer 110. The host computer 110 delegates the GUI 530 to the mobile device 120. The mobile device 120 receives the delegated GUI and generates 540 a corresponding GUI on its touch-sensitive display 130. A user can interact with the GUI on the touch-sensitive display 130. Upon receiving 550 user input, the mobile device 120 sends information describing the interaction to the host computer 110. Depending upon the interaction, the host computer 110 can execute 560 instructions based on the user input, such as by providing the input to an application executing on the host computer 110. In some embodiments, the host computer 110 and mobile device 120 may delegate 570 certain tasks to each other depending upon considerations such as available processing resources.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

It is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method of using a touch-sensitive display of a mobile device with a host computer, comprising:
establishing a communications link between the host computer and the mobile device;
delegating a mirrored graphical user interface (GUI) at a first resolution from the host computer to the touch-sensitive display of the mobile device via the communications link, wherein the mobile device is adapted to show the delegated mirrored GUI on the touch-sensitive display of the mobile device at a second resolution different than the first resolution;
receiving data describing a user interaction with the delegated GUI shown on the touch-sensitive display of the mobile device via the communications link; and
executing an instruction on the host computer based at least in part on the received data describing the user interaction.

2. The computer implemented method of claim 1, wherein establishing a communications link comprises establishing a wireless point-to-point communications link between the host computer and the mobile device.

3. The computer-implemented method of claim 1, wherein establishing a communications link comprises:
establishing a communications link between the host computer and a plurality of mobile devices using a multicast network protocol.

4. The computer-implemented method of claim 1, further comprising registering the touch-sensitive display of the mobile device as an input/output (I/O) device for the host computer.

5. The computer-implemented method of claim 4, wherein the registering registers the touch-sensitive display of the mobile device at a display primitives layer, wherein the host computer can send image rendering and accelerating commands to the mobile device at the display primitives layer.

6. The computer-implemented method of claim 1, further comprising:
receiving updated resolution information associated with a mobile device responsive to a change in orientation of the mobile device; and
updating the GUI responsive to the updated resolution information.

7. The computer-implemented method of claim 1, wherein receiving data describing a user interaction with the delegated GUI comprises receiving gesture-based controls performed by a user on a touch-sensitive display of the mobile device.

8. The computer-implemented method of claim 1, wherein the first resolution is greater than the second resolution, and wherein the mobile device is adapted to allow a user to zoom into the delegated mirrored GUI via a user interaction with the touch-sensitive display.

9. The computer-implemented method of claim 1, further comprising:
generating a customized GUI adapted to the touch-sensitive display; and
delegating the customized GUI to the touch-sensitive display of the mobile device, wherein a user of the mobile device can use the customized GUI to control the host computer.

10. The computer-implemented method of claim 1, wherein the data describing the user interaction with the delegated GUI indicate that a user requested a task be performed by an application executing on the host computer and executing an instruction on the host computer comprises:
interacting with the application executing on the host computer to perform the requested task.

11. The computer-implemented method of claim 1, further comprising:
delegating a task from the host computer to the mobile device responsive to the data describing the user interaction with the delegated GUI.

12. A non-transitory computer-readable storage medium encoded with executable computer program code for using a touch-sensitive display of a mobile device with a host computer, the computer program code comprising program code for:
establishing a communications link between the host computer and the mobile device;
delegating a mirrored graphical user interface (GUI) at a first resolution from the host computer to the touch-sensitive display of the mobile device via the communications link, wherein the mobile device is adapted to show the delegated mirrored GUI on the touch-sensitive display of the mobile device at a second resolution different than the first resolution;
receiving data describing a user interaction with the delegated GUI shown on the touch-sensitive display of the mobile device via the communications link; and
executing an instruction on the host computer based at least in part on the received data describing the user interaction.

13. The non-transitory computer-readable storage medium of claim 12, wherein establishing a communications link comprises establishing a wireless point-to-point communications link between the host computer and the mobile device.

14. The non-transitory computer-readable storage medium of claim 12, wherein establishing a communications link comprises:
establishing a communications link between the host computer and a plurality of mobile devices using a multicast network protocol.

15. The non-transitory computer-readable storage medium of claim 12, further comprising registering the touch-sensitive display of the mobile device as an input/output (I/O) device for the host computer.

16. The non-transitory computer-readable storage medium of claim 12, wherein the registering registers the touch-sensitive display of the mobile device at a display primitives layer, wherein the host computer can send image rendering and accelerating commands to the mobile device at the display primitives layer.

17. The non-transitory computer-readable storage medium of claim 12, further comprising:
receiving updated resolution information associated with a mobile device responsive to a change in orientation of the mobile device; and
updating the GUI responsive to the updated resolution information.

18. The non-transitory computer-readable storage medium of claim 12, wherein receiving data describing a user interaction with the delegated GUI comprises receiving gesture-based controls performed by a user on a touch-sensitive display of the mobile device.

19. The non-transitory computer-readable storage medium of claim 12, wherein the first resolution is greater than the second resolution, and wherein the mobile device is adapted to allow a user to zoom into the delegated mirrored GUI via a user interaction with the touch-sensitive display.

20. The non-transitory computer-readable storage medium of claim 12, further comprising:
generating a customized GUI adapted to the touch-sensitive display; and
delegating the customized GUI to the touch-sensitive display of the mobile device, wherein a user of the mobile device can use the customized GUI to control the host computer.

21. The non-transitory computer-readable storage medium of claim 12, wherein the data describing the user interaction with the delegated GUI indicate that a user requested a task be performed by an application executing on the host computer and executing an instruction on the host computer comprises:
interacting with the application executing on the host computer to perform the requested task.

22. The non-transitory computer-readable storage medium of claim 12, further comprising:
delegating a task from the host computer to the mobile device responsive to the data describing the user interaction with the delegated GUI.

23. A computer for using a touch-sensitive display of a mobile device with a host computer, comprising:
a non-transitory computer-readable storage medium storing executable computer program instructions comprising instructions for:
establishing a communications link between the host computer and the mobile device;
delegating a mirrored graphical user interface (GUI) at a first resolution from the host computer to the touch-sensitive display of the mobile device via the communications link, wherein the mobile device is adapted to show the delegated mirrored GUI on the touch-sensitive display of the mobile device at a second resolution different than the first resolution;
receiving data describing a user interaction with the delegated GUI shown on the touch-sensitive display of the mobile device via the communications link; and
executing an instruction on the host computer based at least in part on the received data describing the user interaction.

24. The computer of claim 23, wherein establishing a communications link comprises establishing a wireless point-to-point communications link between the host computer and the mobile device.

25. The computer of claim 23, wherein establishing a communications link comprises:
establishing a communications link between the host computer and a plurality of mobile devices using a multicast network protocol.

26. The computer of claim 23, further comprising registering the touch-sensitive display of the mobile device as an input/output (I/O) device for the host computer.

27. The computer of claim 26, wherein the registering registers the touch-sensitive display of the mobile device at a display primitives layer, wherein the host computer can send image rendering and accelerating commands to the mobile device at the display primitives layer.

28. The computer of claim 23, further comprising:
receiving updated resolution information associated with a mobile device responsive to a change in orientation of the mobile device; and
updating the GUI responsive to the updated resolution information.

29. The computer of claim 23, wherein receiving data describing a user interaction with the delegated GUI comprises receiving gesture-based controls performed by a user on a touch-sensitive display of the mobile device.

30. The computer of claim 23, wherein the first resolution is greater than the second resolution, and wherein the mobile device is adapted to allow a user to zoom into the delegated mirrored GUI via a user interaction with the touch-sensitive display.

31. The computer of claim 23, further comprising:
generating a customized GUI adapted to the touch-sensitive display; and
delegating the customized GUI to the touch-sensitive display of the mobile device, wherein a user of the mobile device can use the customized GUI to control the host computer.

32. The computer of claim 23, wherein the data describing the user interaction with the delegated GUI indicate that a user requested a task be performed by an application executing on the host computer and executing an instruction on the host computer comprises:
interacting with the application executing on the host computer to perform the requested task.

33. The computer of claim 23, further comprising:
delegating a task from the host computer to the mobile device responsive to the data describing the user interaction with the delegated GUI.
